(19) United States
(12) Patent Application Publication
(10) Pub. No.: US 2012/0305754 A1
(43) Pub. Date: Dec. 6, 2012

(54) OPTICAL PROBE, COVERING MEMBER, MEASUREMENT METHOD FOR AN OPTICAL PROBE, AND OPTICAL POWER METER

(75) Inventor: Takashi Yamaguchi, Kanagawa (JP)

(73) Assignee: SONY CORPORATION, Tokyo (JP)

(21) Appl. No.: 13/477,614

(22) Filed: May 22, 2012

(30) Foreign Application Priority Data
May 31, 2011 (JP) 2011-122275

(51) Int. Cl. G02B 6/26; G01J 1/04

(52) U.S. Cl. 250/227.11; 385/31

(57) ABSTRACT

An optical probe includes an optical probe main body and a covering member. The optical probe main body includes a light-emitting portion configured to emit laser light. The covering member is configured to cover a part of the optical probe main body from the light-emitting portion such that laser light from the light-emitting portion can be emitted to an outside, and to be detachable from the optical probe main body.

### BACKGROUND

The present disclosure relates to an optical probe, a covering member, a measurement method for an optical probe, and an optical power meter.

In recent years, applied researches for inserting into a vessel an optical probe including, at a tip end thereof, a light-emitting portion have been started. The optical probe is one to be inserted into a vessel, and thus needs to secure cleanness more strict than in the past. Also, it is important to control an output intensity of laser light from the light-emitting portion of the optical probe.

In use, a light input portion of the optical probe is attached to a light output port of a laser apparatus and the tip end of the optical probe is inserted into a vessel. The laser apparatus includes an optical power meter that measures an output intensity of laser light from the light-emitting portion of the optical probe. Before use, a user moves the light-emitting portion of the optical probe closer to the optical power meter and checks an output intensity of laser light from the light-emitting portion of the optical probe.

Since the optical power meter is not sterilized, it is not appropriate to bring the light-emitting portion of the optical probe into direct contact with the optical power meter. Therefore, the light-emitting portion of the optical probe is inserted into an applicator that has been subjected to sterilization, and attached to the optical power meter of the laser apparatus via the applicator (see PD laser (revised on Aug. 18, 2008), (http://www.info.pmda.go.jp/downfiles/md/PDF/730056_{—}216 00BZZ00026000 A_{—}01_{—}02.pdf).

### SUMMARY

There is a possibility that the light-emitting portion of the optical probe may be brought close to or into contact with an unsanitary area of the laser apparatus due to an erroneous operation by the user or the like. Also, there is a problem that the applicator needs to be subjected to sterilization for each use, which contributes to low work efficiency.

In view of the above circumstances, there is a need for an optical probe, a covering member, a measurement method for an optical probe, and an optical power meter that are capable of checking an output intensity of laser light while securing cleanness without deteriorating work efficiency.

According to an embodiment of the present disclosure, there is provided an optical probe including an optical probe main body and a covering member.

The optical probe main body includes a light-emitting portion configured to emit laser light. The covering member is configured to cover a part of the optical probe main body from the light-emitting portion such that laser light from the light-emitting portion can be emitted to an outside, and to be detachable from the optical probe main body.

In the embodiment of the present disclosure, since the covering member covers a part of the optical probe main body, an output intensity of laser light of the optical probe main body can be checked with the optical probe main body being covered with the covering member without direct contact with the optical probe main body. Therefore, when an output intensity of laser light is checked, the optical probe main body inserted into a body cavity such as a vessel is prevented from being brought close to or into contact with an unsanitary area due to an erroneous operation. Thus, it is possible to reliably secure cleanness of the optical probe main body. Moreover, since the covering member is configured to be detachable from the optical probe main body, it is possible to reliably secure cleanness of the optical probe main body by the covering member just before the covering member is detached from the optical probe main body for use of the optical probe main body.

The covering member may include a shutter member, an engagement portion, and a link mechanism.

The shutter member is openable and closable and configured to block the light-emitting portion. The engagement portion is configured to be, when the optical probe is inserted into a measurement portion configured to measure an output intensity of laser light from the light-emitting portion, engaged to an engagement mechanism provided to the measurement portion. The link mechanism is configured to open, when the engagement portion is engaged to the engagement mechanism, the shutter member by engagement action.

In the embodiment of the present disclosure, the engagement portion of the optical probe is configured to open, when the engagement portion is engaged to the engagement mechanism, the shutter member by engagement action. Therefore, until the optical probe is completely inserted into the measurement portion, the light-emitting portion is blocked by the shutter member and prevented from being brought close to or into contact with an unsanitary area. Thus, it is possible to reliably secure cleanness of the light-emitting portion of the optical probe main body.

The covering member may include a sandwiching mechanism configured to sandwich the optical probe main body with an elastic force and to make the covering member detachable from the optical probe main body by releasing the elastic force.

In the embodiment of the present disclosure, by controlling the sandwiching mechanism, it is possible to control the sandwiching of the optical probe main body by the covering member and the detachment of the covering member from the optical probe main body.

The covering member may include a groove configured to be, when the optical probe is inserted into the measurement portion, engaged to a locking mechanism provided to the measurement portion.

In the embodiment of the present disclosure, since the covering member includes the groove configured to be engaged to the locking mechanism, the optical probe can be fixed at a predetermined position of the measurement portion by the engagement between the groove and the locking mechanism. Thus, for example, during measurement of an output intensity of laser light, the optical probe is prevented from being detached from the measurement portion.

The covering member may include a tip end portion, a sandwiching portion, and an extending portion.

The tip end portion is configured to cover an end portion on a side of the light-emitting portion of the optical probe main body and to be engaged to a measurement portion configured to measure an output intensity of laser light from the light-emitting portion. The sandwiching portion is connected to the tip end portion and configured to sandwich the optical probe main body by a sandwiching mechanism configured to be detachable from the optical probe main body. The extending portion has a tubular shape, which is connected to the sandwiching portion and configured to hold the optical probe main body.

In the embodiment of the present disclosure, also when the tip end portion is inserted into the measurement portion, the optical probe main body not inserted into the measurement portion is covered with the sandwiching portion and the extending portion of the covering member, and thus it is possible to reliably secure cleanness of the optical probe main body.

The covering member includes an insertion hole into which the optical probe main body is to be inserted, and the insertion hole has a size increasing at a second end portion on an opposite side to a first end portion of the covering member on a side of the light-emitting portion.

In the embodiment of the present disclosure, the insertion hole of the covering member has a size increasing at the second end portion. Therefore, when the covering member is detached from the optical probe main body by pulling out the optical probe main body from the second end portion of the covering member, the light-emitting portion is less likely to be brought into contact with the second end portion. Thus, even if dirt and the like are adhered to the second end portion of the covering member, the light-emitting portion is less likely to be brought into contact with the second end portion, and thus the dirt and the like are less likely to be adhered to the light-emitting portion.

The covering member may be formed of material that can be subjected to ethylene oxide gas sterilization or radiation sterilization.

In the embodiment of the present disclosure, the covering member is formed of material that can be subjected to ethylene oxide gas sterilization or radiation sterilization. Thus, the entire optical probe can be subjected to sterilization.

The covering member may include a removable lid configured to block the light-emitting portion.

In the embodiment of the present disclosure, since the lid is provided, it is possible to reliably secure cleanness of the light-emitting portion.

The covering member may include a window portion configured to block the light-emitting portion and to be capable of transmitting laser light therethrough.

In the embodiment of the present disclosure, since the window portion is provided, it is possible to reliably cleanness of the light-emitting portion. Moreover, since the window portion is capable of transmitting laser light therethrough, an output intensity of laser light can be measured while reliably securing cleanness without removing the window portion.

According to an embodiment of the present disclosure, there is provided a covering member, configured to cover a part of an optical probe main body including a light-emitting portion configured to emit laser light, from the light-emitting portion, such that laser light from the light-emitting portion of the optical probe main body can be emitted to an outside, and to be detachable from the optical probe main body.

In the embodiment of the present disclosure, since the covering member covers a part of the optical probe main body, an output intensity of laser light of the optical probe main body can be checked with the optical probe main body being covered with the covering member without direct contact with the optical probe main body. Therefore, when an output intensity of laser light is checked, the optical probe main body inserted into a body cavity such as a vessel is prevented from being brought close to or into contact with an unsanitary area due to an erroneous operation. Thus, it is possible to reliably cleanness of the optical probe main body. Moreover, since the covering member is configured to be detachable from the optical probe main body, it is possible to reliably secure cleanness of the optical probe main body by the covering member just before the covering member is detached from the optical probe main body for use of the optical probe main body.

According to an embodiment of the present disclosure, there is provided a measurement method for an optical probe, the optical probe including an optical probe main body including a light-emitting portion configured to emit laser light, and a covering member including an engagement portion and an openable and closable shutter member configured to cover a part of the optical probe main body from the light-emitting portion and to block the light-emitting portion, the covering member being configured to be detachable from the optical probe main body, the measurement method including: inserting the part on a side of the light-emitting portion of the optical probe into a measurement portion of an optical power meter, the part being covered with the covering member, the measurement portion being configured to measure an output intensity of laser light; engaging the engagement portion to an engagement mechanism provided to the measurement portion of the optical power meter by the insertion to open the shutter member by engagement action when the engagement portion is engaged to the engagement mechanism; and outputting laser light from the light-emitting portion with the engagement portion being engaged to the engagement mechanism to measure laser light from the light-emitting portion by the optical power meter.

In the embodiment of the present disclosure, since the shutter member is opened by the engagement action when the engagement portion of the optical probe is engaged to the engagement mechanism provided to the measurement portion. Therefore, before the optical probe is completely inserted into the measurement portion, the light-emitting portion is blocked by the shutter member and prevented from being brought close to or into contact with an unsanitary area. Thus, while securing cleanness of the light-emitting portion of the optical probe main body, an output intensity of laser light of the optical probe main body can be checked.

According to an embodiment of the present disclosure, there is provided an optical power meter including a measurement portion and an engagement mechanism.

The measurement portion is configured to measure an output intensity of laser light from a light-emitting portion of an optical probe including an optical probe main body including the light-emitting portion configured to emit laser light, and a covering member including an engagement portion and an openable and closable shutter member configured to cover a part of the optical probe main body from the light-emitting portion and to block the light-emitting portion, the covering member being configured to be detachable from the optical probe main body. The engagement mechanism is provided to the measurement portion and configured to be, when the optical probe is inserted into the measurement portion, engaged to the engagement portion to open the shutter member by engagement action.

In the embodiment of the present disclosure, since the shutter member is opened by the engagement action when the engagement portion of the optical probe is engaged to the engagement mechanism provided to the measurement portion. Therefore, before the optical probe is completely inserted into the measurement portion, the light-emitting portion is blocked by the shutter member and prevented from being brought close to or into contact with an unsanitary area. Thus, while securing cleanness of the light-emitting portion of the optical probe main body, an output intensity of laser light of the optical probe main body can be checked.

As described above, according to the embodiments of the present disclosure, it is possible to reliably secure cleanness of the optical probe main body.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a perspective view of an optical probe according to an embodiment of the present disclosure;

FIG. 2 is a partial enlarged view showing vicinities of a sandwiching portion and a tip end portion of the optical probe shown in FIG. 1;

FIG. 3 is a plan view of the tip end portion of the optical probe as viewed from the arrow III of FIG. 2, which shows a state in which a shutter member is closed;

FIG. 4 is a vertical cross-sectional view of the tip end portion of the optical probe that is taken along the line IV-IV′ of FIG. 3, which corresponds to an area surrounded by the circle IV of FIG. 2;

FIG. 5 is a plan view of the tip end portion of the optical probe as viewed from the arrow III of FIG. 2, which shows a state in which the shutter member is opened;

FIG. 6 is a vertical cross-sectional view of the tip end portion of the optical probe that is taken along the line VI-VI′ of FIG. 5, which corresponds to an area surrounded by the circle IV of FIG. 2;

FIG. 7 is a vertical cross-sectional view taken along a longitudinal direction of the optical probe in a position in which an optical probe main body is located and corresponds to an area surrounded by the circle VII of FIG. 2, which shows a state in which the optical probe main body is sandwiched by a sandwiching mechanism of an applicator;

FIG. 8 is a vertical cross-sectional view taken along the line VIII-VIII′ of FIG. 7;

FIG. 9 is a vertical cross-sectional view taken along the longitudinal direction of the optical probe in the position in which the optical probe main body is located, which corresponds to an area surrounded by the circle VII of FIG. 2 and shows a state in which the sandwiching of the optical probe main body by the sandwiching mechanism of the applicator is released;

FIG. 10 is a vertical cross-sectional view taken along the line X-X′ of FIG. 9;

FIG. 11 is a perspective view showing a state in which the optical probe shown in FIG. 1 is sterilized and packed;

FIG. 12 is a perspective view of a laser apparatus including an optical power meter according to an embodiment of the present disclosure, which shows a state in which the tip end portion of the optical probe is inserted into an output intensity measurement portion of the optical power meter;

FIG. 13 is a partial cross-sectional view as the output intensity measurement portion of the laser apparatus including the optical power meter shown in FIG. 12 is viewed from the above in the figure, which shows a state in which locking mechanisms provided to the output intensity measurement portion is engaged to grooves of the tip end portion of the optical probe;

FIG. 14 is a vertical cross-sectional view of the output intensity measurement portion that is taken along the line XIV-XIV′ of FIG. 12, which shows a state in which the locking mechanisms provided to the output intensity measurement portion is engaged to the grooves of the tip end portion of the optical probe;

FIG. 15 is a partial cross-sectional view as the output intensity measurement portion of the laser apparatus including the optical power meter that is shown in FIG. 12 is viewed from the above in the figure, which shows a state in which the engagement between the grooves of the tip end portion of the optical probe and the locking mechanisms provided to the output intensity measurement portion is released;

FIG. 16 is a vertical cross-sectional view of the output intensity measurement portion that is taken along the line XIV-XIV′ of FIG. 12, which shows a state in which the engagement between the grooves of the tip end portion of the optical probe and the locking mechanisms provided to the output intensity measurement portion is released;

FIG. 17 is a vertical cross-sectional view of the output intensity measurement portion that is taken along the line XIV-XIV′ of FIG. 12, which shows a state in which the engagement between the grooves of the tip end portion of the optical probe and the locking mechanisms provided to the output intensity measurement portion is released and the tip end portion of the optical probe is pulled out of the output intensity measurement portion;

FIG. 18 is a simplified vertical cross-sectional view of the output intensity measurement portion of the laser apparatus including the optical power meter that is shown in FIG. 12;

FIG. 19 is a vertical cross-sectional view of the output intensity measurement portion, which shows a state in which, with the tip end portion of the optical probe being inserted into the output intensity measurement portion shown in FIG. 18, an output of laser light of the optical probe main body is measured;

FIG. 20 is a perspective view showing a state in which after measurement of an output intensity of laser light by the laser apparatus including the optical power meter that is shown in FIG. 12, the tip end portion of the applicator is pulled out of the output intensity measurement portion;

FIG. 21 is a perspective view showing a state in which after the applicator is pulled out of the output intensity measurement portion of the laser apparatus including the optical power meter that is shown in FIG. 12, the applicator is detached from the optical probe;

FIG. 22 is a cross-sectional view showing a structure of a tip end portion of an applicator of an optical probe as a modified example 1;

FIG. 23A is a cross-sectional view showing a structure of a tip end portion of an applicator of an optical probe as a modified example 2, which shows a state in which a lid is attached;

FIG. 23B is a cross-sectional view showing a structure of the tip end portion of the applicator of the optical probe as the modified example 2, which shows a state in which the lid is removed;

FIG. 24 is a partial vertical cross-sectional view showing a sandwiching mechanism in a sandwiching portion of an applicator as a modified example 3, which shows a state in which the sandwiching of an optical probe main body by an elastic member is released;

FIG. 25 is a cross-sectional view taken along the line XXV-XXV′ of FIG. 24;

FIG. 26 is a partial vertical cross-sectional view showing the sandwiching mechanism in the sandwiching portion of the applicator as the modified example 3, which shows a state in which the optical probe main body is sandwiched by the elastic member;

FIG. 27 is a cross-sectional view taken along the line XXVII-XXVII′ of FIG. 26;

FIG. 28A is a plan view of a sandwiching mechanism in a sandwiching portion of an applicator as a modified example 4, which shows a state in which the sandwiching of an optical probe main body is released;

FIG. 28B is a plan view of the sandwiching mechanism in the sandwiching portion of the applicator as the modified example 4, which shows a state in which the optical probe main body is sandwiched; and

FIG. 29 is a perspective view showing a structure of an optical probe as a modified example 5.

### DETAILED DESCRIPTION OF EMBODIMENTS

Hereinafter, embodiments according to the present disclosure will be described with reference to the drawings.

[Structure of Optical Probe]

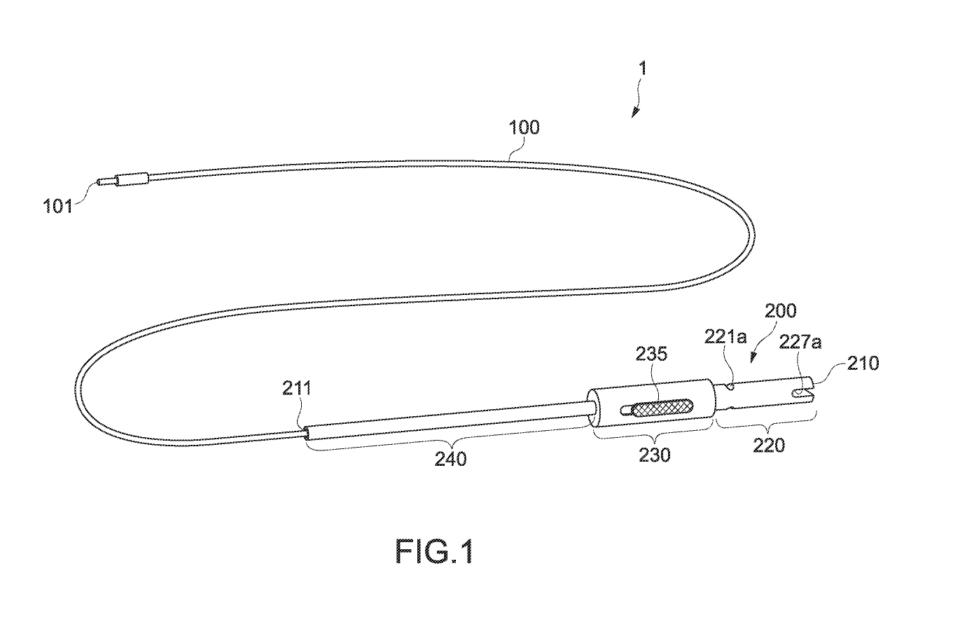

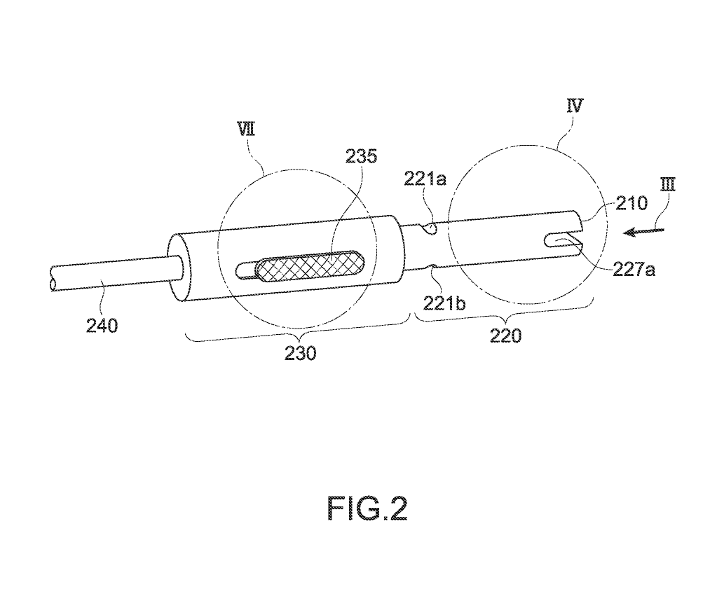

FIG. 1 is a perspective view of an optical probe according to an embodiment of the present disclosure. FIG. 2 is a partial enlarged view showing vicinities of a sandwiching portion and a tip end portion of the optical probe shown in FIG. 1.

As shown in FIGS. 1 and 2, an optical probe 1 as an optical transmission apparatus includes an optical probe main body 100 as an optical transmission apparatus main body and an applicator 200 as a covering member.

The optical probe main body 100 is inserted into a body cavity such as a vessel and its light-emitting portion 102 emits laser light. In the optical probe main body 100, before the insertion into the body cavity, an output intensity of laser light from the light-emitting portion of the optical probe main body 100 is measured by an optical power meter. An output intensity of laser light is measured in a state in which the applicator 200 is attached to the optical probe main body 100. After measurement, a sandwiching function of the applicator 200 is released and the applicator 200 is pulled out of the optical probe main body 100. In this state, operation using the optical probe main body 100 is performed. An area of the optical probe main body 100, which is to be inserted into the body cavity, is covered with the applicator 200. Thus, since the optical probe main body 100 is not contaminated due to proximity to or contact with an unsanitary area of the optical power meter, it is possible to keep cleanness of the optical probe main body 100.

The entire length of the optical probe main body 100 is, for example, 3 m. The entire length of the applicator 200 is, for example, approximately 1.1 m to 1.2 m. During operation, the optical probe main body 100 is inserted into a body by about 1 m, for example.

The optical probe main body 100 is one that transmits laser light therethrough. The optical probe main body 100 includes, at one end portion thereof, a light input portion 101 that is connected to a light source of the laser apparatus and, at the other end portion, the light-emitting portion 102 (see FIG. 4) that emits laser light. The light input portion 101 is provided with an FC type or SMA type optical connector (not shown), for example, and is connected to the light source of the laser apparatus. The light-emitting portion 102 is inserted into the body cavity during operation.

The applicator 200 covers a part of the optical probe main body 100 such that laser light from the light-emitting portion 102 of the optical probe main body 100 can be emitted to an outside. The applicator 200 is detachable from the optical probe main body 100. The applicator 200 includes a tip end portion 220, a sandwiching portion 230, and an extending portion 240. Regarding the tip end portion 220, the sandwiching portion 230, and the extending portion 240, the tip end portion 220 and the extending portion 240 are arranged to sandwich the sandwiching portion 230 and these are coupled to each other. The length of the extending portion 240 is about 1 m. The combined length of the tip end portion 220 and the sandwiching portion 230 is approximately 10 cm to 20 cm. The applicator 200 has an insertion hole 290 (e.g., see FIG. 4) into which the optical probe main body 100 is to be inserted.

The tip end portion 220 covers a vicinity of an end portion on a side of the light-emitting portion 102 of the optical probe main body 100. The tip end portion 220 is a portion to be, during the measurement of an output intensity of laser light, inserted into an output intensity measurement portion of the optical power meter and engaged thereto. It should be noted that details of a structure of the optical power meter will be described later.

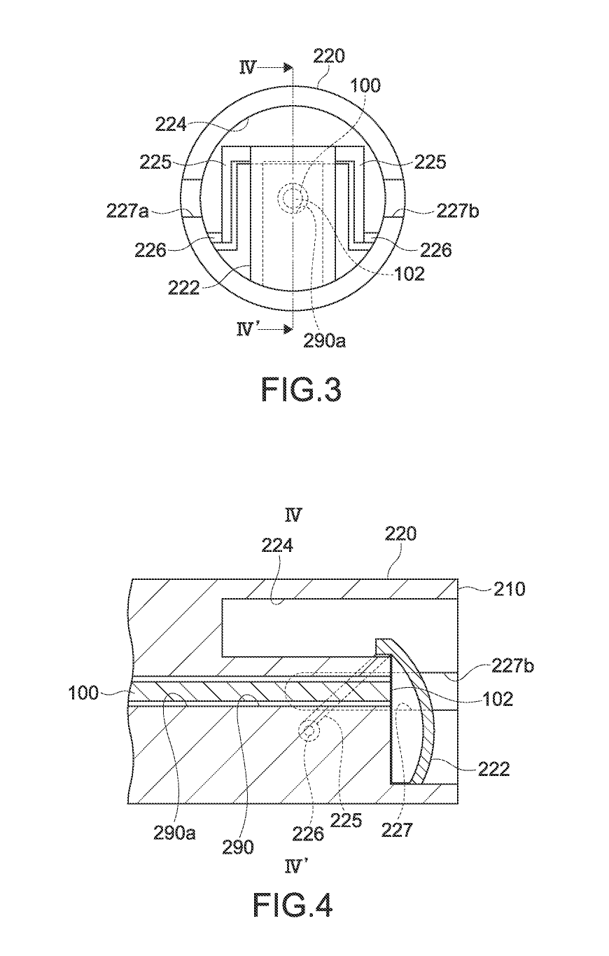

FIGS. 3 to 6 each show a structure of the tip end portion 220.

The tip end portion 220 includes, at an outer surface thereof, grooves 221a and 221b as shown in FIGS. 1 and 2, an openable and closable shutter member 222 that blocks the light-emitting portion provided near a one end portion 210 as shown in FIGS. 3 and 4, and cutouts 227a and 227b as engagement portions that are provided to the one end portion 210 to extend in a longitudinal direction. The two grooves 221a and 221b are opposed to each other. The two cutouts 227a and 227b are also opposed to each other.

As shown in FIGS. 3 to 6, the tip end portion 220 includes shutter member shafts 225 and pins 226. The shutter member shafts 225 are fixedly connected to the shutter member 222 to cooperate with the shutter member 222. The shutter member 222 and the shutter member shafts 225 that are fixedly connected to each other and the pins 226 constitute a link mechanism for opening the shutter member 222. The two pins 226 are opposed to each other along a direction orthogonal to a longitudinal direction of the applicator 200 and fixedly provided in the tip end portion 220. The two shutter member shafts 225 are connected to the corresponding pins 226 to be rotatable. The shutter member shafts 225 are each fixed and connected to both sides of the shutter member 222. The shutter member shafts 225 and the shutter member 222 rotate with the pins 226 as support shafts being rotation support points, so that the shutter member 222 is opened or closed.

The two cutouts 227a and 227b serve as guides through which two shutter member open pins 503a and 503b provided as engagement mechanisms to the output intensity measurement portion pass when the tip end portion 220 of the applicator 200 is inserted into the output intensity measurement portion of the optical power meter. The two cutouts 227a and 227b are opposed to each other along a direction orthogonal to the longitudinal direction of the applicator 200.

When the optical probe 1 is not yet inserted into the output intensity measurement portion of the optical power meter, the shutter member 222 is closed and the light-emitting portion 102 is blocked as shown in FIGS. 3 and 4. Thus, since proximity to or contact with the unsanitary area in the outside is not caused, it is possible to secure cleanness of the light-emitting portion 102.

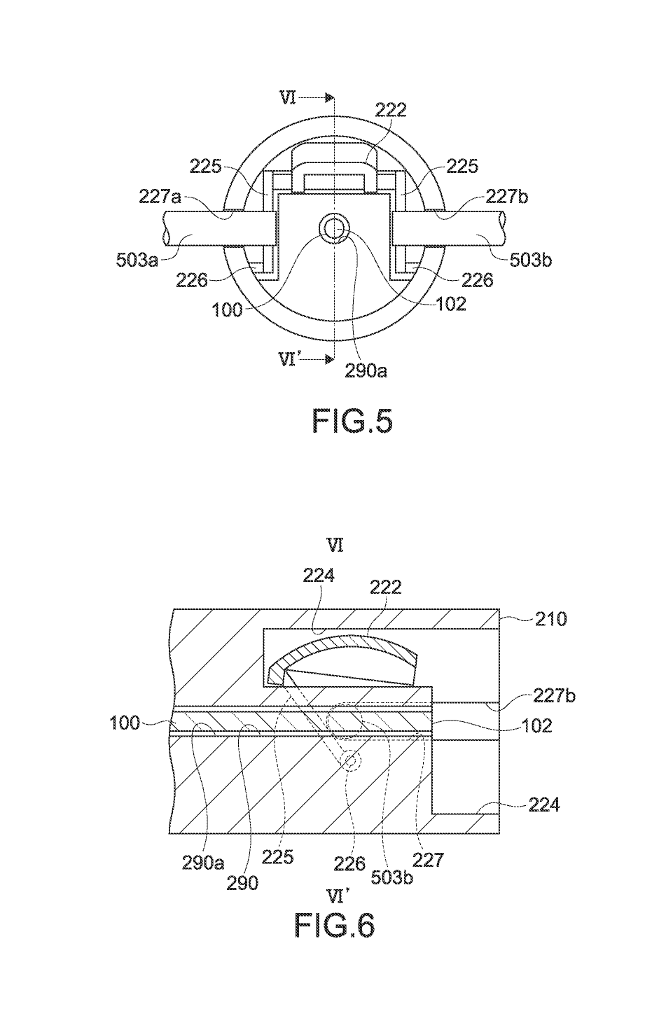

As shown in FIGS. 5 and 6, when the optical probe 1 is inserted into the output intensity measurement portion of the optical power meter, due to the insertion, the shutter member open pin 503a (503b) provided as the engagement mechanisms to the output intensity measurement portion is engaged to the cutout 227a (227b) being the engagement portion. Then, the shutter member open pins 503a and 503b push the shutter member shafts 225 toward a direction opposite to an insertion direction of the applicator 200. When the shutter member shafts 225 are pushed by the shutter member open pins 503a and 503b, the shutter member shafts 225 and the shutter member 222 fixedly connected to the shutter member shafts 225 rotates with respect to the pins 226. Thus, the shutter member 222 is opened and the light-emitting portion 102 is exposed. As described above, the tip end portion 220 of the applicator 200 has a link mechanism in which the operation of the shutter member open pins 503a and 503b pushing the shutter member shafts 225 leads to the operation of the shutter member 222 being opened.

As shown in FIGS. 3 to 6, the tip end portion 220 has an insertion hole 290a extending through the tip end portion 220. The insertion hole 290a is located almost at a center of the tip end portion 220 and extends in a longitudinal direction of the tip end portion 220. The tip end portion 220 is provided with a recess portion 224 for making a space for an area in which the shutter member 222 and the shutter member shafts 225 move during opening and closing and an area into which the shutter member open pins 503a and 503b provided to the output intensity measurement portion of the optical power meter are inserted. The space formed by the recess portion 224 serves as an area in which the shutter member 222 and the shutter member shafts 225 can move. The space formed by the recess portion 224 and the space within the insertion hole 290a are continuous with each other.

The insertion hole 290a has, as taken along a cross section orthogonal to the longitudinal direction of the tip end portion 220, a circular shape similar to a shape of a cross section of the optical probe main body 100. The insertion hole 290a has a diameter slightly larger than a diameter of the optical probe main body 100. The optical probe main body 100 is inserted and held in the insertion hole 290a. During the insertion, the light-emitting portion 102 of the optical probe main body 100 does not extend into the recess portion 224 but is positioned within the insertion hole 290a.

During the insertion into the output intensity measurement portion of the optical power meter, locking rods (not shown) provided as locking mechanisms to the output intensity measurement portion are engaged to the grooves 221a and 221b. Due to this engagement, a position of the tip end portion 220 in the output intensity measurement portion is fixed and locked. A detailed structure of the engagement mechanisms provided to the output intensity measurement portion will be described later.

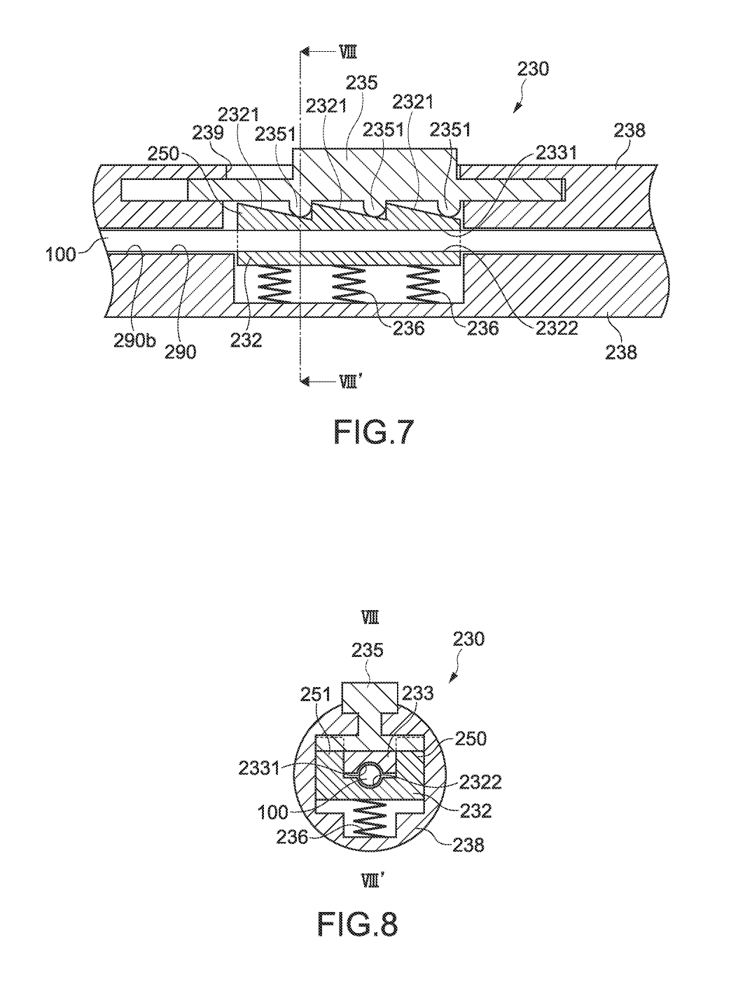

FIGS. 7 to 10 each show a structure of the sandwiching portion.

As shown in FIGS. 7 to 10, the sandwiching portion 230 includes an optical probe main body upper fixing member 233, an optical probe main body lower fixing member 232, a first member 238, springs 236, and an applicator attachment and detachment slide button 235. The sandwiching portion 230 has a sandwiching mechanism in which the optical probe main body is sandwiched with an elastic force and by releasing the elastic force, the applicator 200 is made to be detachable from the optical probe main body.

The sandwiching mechanism of the sandwiching portion 230 is constituted by the optical probe main body upper fixing member 233, the optical probe main body lower fixing member 232, the first member 238, the springs 236, and the applicator attachment and detachment slide button 235.

The optical probe main body upper fixing member 233 and the optical probe main body lower fixing member 232 are those that fix and hold the optical probe main body 100 by sandwiching the optical probe main body 100 in upper and lower directions in the figures. The optical probe main body upper fixing member 233 and the optical probe main body lower fixing member 232 include, on opposed-surface sides thereof, an upper recess portion 2331 and a lower recess portion 2322, respectively. The upper recess portion 2331 and the lower recess portion 2322 each have a semi-circular cross section. The optical probe main body 1 is held in a space formed by the upper recess portion 2331 and the lower recess portion 2322 when the optical probe main body upper fixing member 233 and the optical probe main body lower fixing member 232 are combined. The upper recess portion 2331 and the lower recess portion 2322 form an insertion hole 290b. The insertion hole 290b and the insertion hole 290a of the tip end portion 220 are continuous with each other. When the optical probe main body upper fixing member 233 and the optical probe main body lower fixing member 232 are combined and the optical probe main body 1 is held by the sandwiching mechanism with the elastic force, a circular cross section of the insertion hole 290b formed by the upper recess portion 2331 and the lower recess portion 2322 has almost the same diameter as the diameter of the optical probe main body 100.

The first member 238 is formed to cover the springs 236, the optical probe main body upper fixing member 233, the optical probe main body lower fixing member 232, and a part of the applicator attachment and detachment slide button 235. In the first member 238, a slide recess portion 239 is formed for making a space for an area in which the applicator attachment and detachment slide button 235 slides. Movements of the springs 236, the optical probe main body upper fixing member 233, and the optical probe main body lower fixing member 232 in directions (upper and lower directions in figures) the same as expansion and contraction directions of the springs 236 are limited by the first member 238.

The optical probe main body lower fixing member 232 includes a first projecting portion 250 and a second projecting portion 251 on both sides thereof sandwiching the optical probe main body 1. The two first projecting portion 250 and second projecting portion 251 are arranged in parallel and extend in a longitudinal direction. The optical probe main body upper fixing member 233 is provided to be fitted in a space sandwiched by the first projecting portion 250 and the second projecting portion 251.

The springs 236 are provided between the optical probe main body lower fixing member 232 and the first member 238 while being fixed to the optical probe main body lower fixing member 232 and the first member 238.

A distance between the optical probe main body upper fixing member 233 and the optical probe main body lower fixing member 232 changes due to expansion and contraction of the springs 236. As shown in FIG. 8, in a state in which the springs 236 are expanded, the optical probe main body upper fixing member 233 and the optical probe main body lower fixing member 232 move closer to each other and sandwich and fix the optical probe main body 100 in a space formed by the upper recess portion 2331 and the lower recess portion 2322. On the other hand, as shown in FIG. 10, when the springs 236 are contracted, the optical probe main body upper fixing member 233 and the optical probe main body lower fixing member 232 move away from each other and the sandwiching of the optical probe main body 100 is released. At this time, the optical probe main body 100 is detachable from the applicator 200. As described above, by using expansion and contraction properties of the springs 236 to sandwich the optical probe main body 100 with an elastic force and release the elastic force, the applicator 200 is made to be detachable from the optical probe main body 100.

The applicator attachment and detachment slide button 235 is provided in the slide recess portion 239 of the first member 238 and a part of the applicator attachment and detachment slide button 235, which is to be operated by the user, is exposed. The applicator attachment and detachment slide button 235 includes a plurality of protruding portions 2351 on a surface thereof on a side of the optical probe main body lower fixing member 232. The protruding portions 2351 each have a semicircular column shape. A longitudinal direction of the protruding portions 2351 is orthogonal to a movement direction of the applicator attachment and detachment slide button 235.

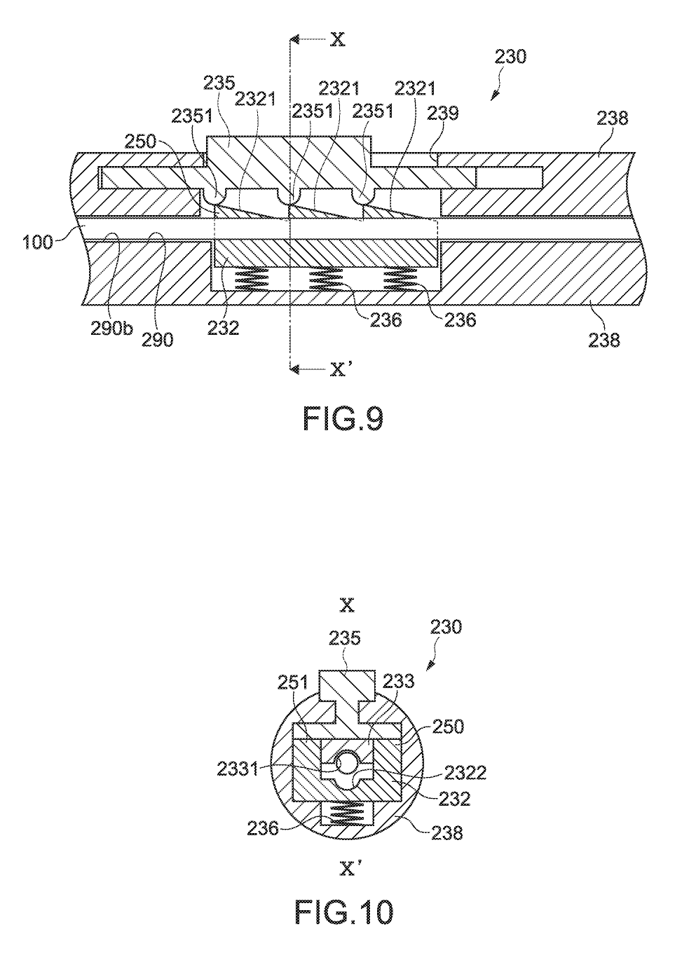

Regarding the first projecting portion 250 and the second projecting portion 251 of the optical probe main body lower fixing member 232, as shown in FIGS. 7 and 9, on each surface, a plurality of tilted surfaces 2321 are provided. The tilted surfaces 2321 are arranged in parallel at constant intervals in a longitudinal direction. In this case, by sliding the applicator attachment and detachment slide button 235 in a left-hand direction in the figures, the sandwiching of the optical probe main body by the sandwiching mechanism is released. In FIGS. 7 and 9, the tilted surfaces 2321 each have a height gradually increasing from a right hand to a left hand. In other words, the tilted surfaces 2321 are provided to each have a height increasing toward a direction the same as the movement direction of the applicator attachment and detachment slide button 235 upon the release of the sandwiching. Peak portions of the tilted surfaces 2321 extend in parallel to the longitudinal direction of the protruding portions 2351. Each of the tilted surfaces 2321 is provided to correspond to each of the protruding portions 2351.

As shown in FIGS. 7 and 8, when the applicator attachment and detachment slide button 235 is positioned on a right-hand side in the slide recess portion 239 in FIG. 7, the protruding portions 2351 of the applicator attachment and detachment slide button 235 are positioned on lower portions of the tilted surfaces 2321. At this time, the springs 236 are in an expanded state, and the optical probe main body 100 is sandwiched between the optical probe main body upper fixing member 233 and the optical probe main body lower fixing member 232 and fixed and held by them.

As shown in FIGS. 9 and 10, by moving the applicator attachment and detachment slide button 235 from the right hand to the left hand in the slide recess portion 239 in FIG. 7, the protruding portions 2351 move from the right hand to the left hand over the tilted surfaces 2321 with respect to the optical probe main body lower fixing member 232. Accordingly, the protruding portions 2351 move from a lower portion side to a peak portion side of the tilted surfaces 2321, and the optical probe main body lower fixing member 232 is pushed to move in the lower direction in the figure by an amount of change of a contact position between the protruding portions 2351 and the tilted surfaces 2321 in a height direction. Then, the springs 236 are contracted due to the movement of the optical probe main body lower fixing member 232 in the lower direction in the figure. As described above, due to this contraction of the springs 236, the optical probe main body upper fixing member 233 and the optical probe main body lower fixing member 232 move away from each other and the sandwiching of the optical probe main body 100 by the sandwiching mechanism is released. Thus, the applicator 200 can be removed from the optical probe main body 100.

The extending portion 240 has a cylindrical tubular shape. The extending portion 240 is connected to the sandwiching portion 230 and has an insertion hole. An inner diameter of the extending portion 240 is slightly larger than a diameter of the optical probe main body 100. The insertion hole 290 of the applicator 200 is formed by connecting the insertion hole 290a of the tip end portion 220, the insertion hole 290b of the sandwiching portion 230, and the insertion hole of the extending portion 240. In the insertion hole 290, the optical probe main body 100 is held.

The applicator 200 is made of a member that can be subjected to EOG (ethylene oxide gas) sterilization or radiation sterilization. For example, for the sandwiching portion 230 and the tip end portion 220, polycarbonate or polypropylene can be used. For the extending portion 240, polyurethane or the like can be used. The sandwiching portion 230 and the tip end portion 220 are not flexible and hold the optical probe main body 100 in a straight state. The extending portion 240 is flexible and capable of holding the optical probe main body 100 in a bent state. In order to prevent laser light from leaking to the outside during measurement of laser light output intensity, the tip end portion 220 can be made of opaque material, that is, for example, material colored in black or the like.

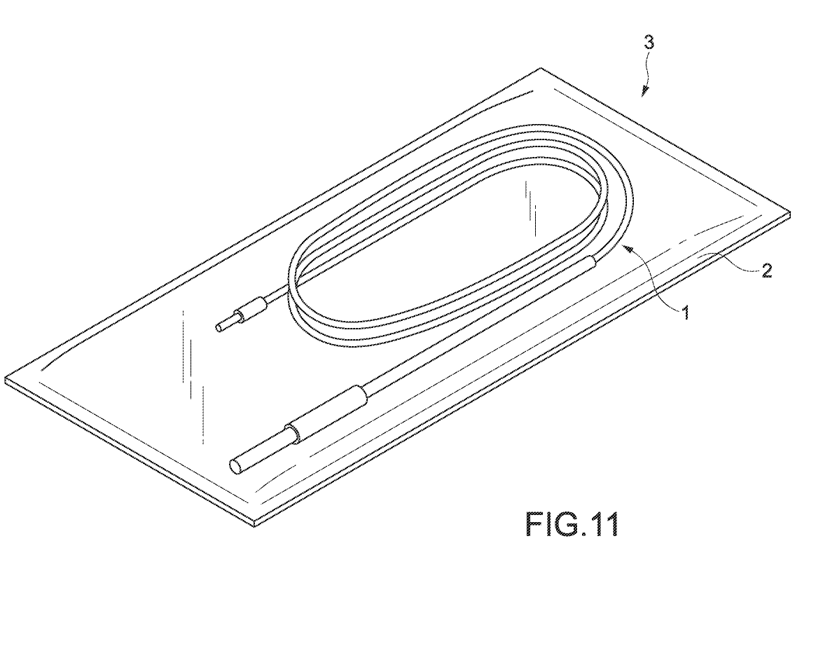

FIG. 11 is a perspective view showing a state in which the optical probe 1 is sterilized and packed.

As shown in FIG. 11, the optical probe 1 is subjected to EOG (ethylene oxide gas) sterilization or radiation sterilization together with a package 2 and packed as the packed optical probe 3. The optical probe 1 in this packed optical probe 3 state is provided to a medical institution. In use, the package 2 is opened and the optical probe 1 is removed therefrom.

[Structure of Laser Light Output Apparatus Including Optical Power Meter]

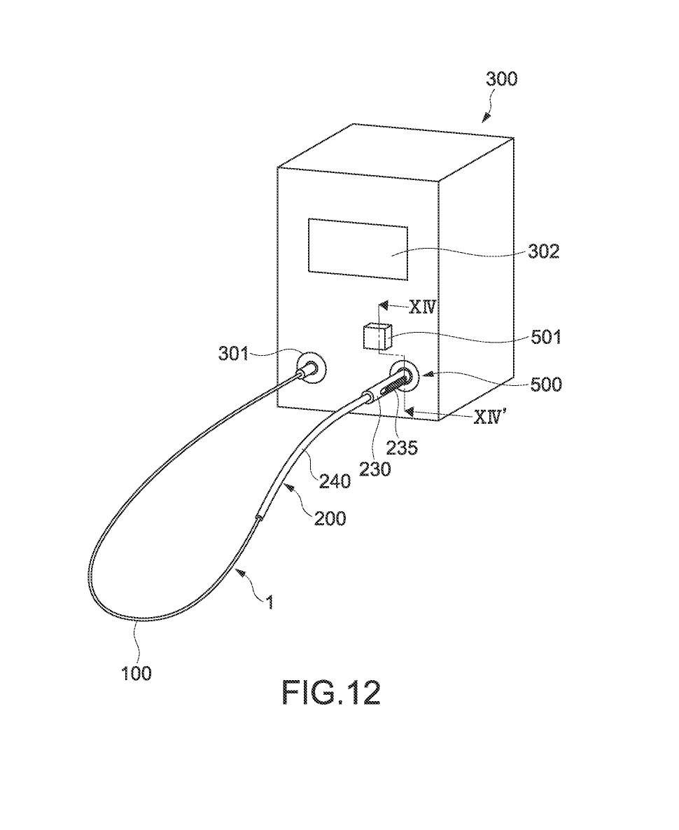

FIG. 12 is a perspective view of a laser apparatus including an optical power meter according to an embodiment of the present disclosure, which shows a state in which laser light output intensity of the above-mentioned optical probe 1 is measured using the laser apparatus including the optical power meter.

As shown in FIG. 12, a laser apparatus 300 including an optical power meter that measures an output intensity of laser light includes a laser light source 301, an output intensity measurement portion 500, a lock release button 501, and a display screen 302 on which an intensity value of laser light and the like are displayed. The laser apparatus 300 including the optical power meter has a laser light output function and a laser light output intensity measurement function for the optical probe main body. The optical power meter is constituted of the output intensity measurement portion 500, the lock release button 501, and the display screen 302.

The laser light source 301 emits laser light. During output intensity measurement and operation of the optical probe 1, the light input portion 101 of the optical probe main body 100 is connected to the laser light source 301 and the light-emitting portion 102 of the optical probe main body 100 emits laser light.

The output intensity measurement portion 500 is a portion into which the tip end portion 220 of the applicator 200 of the optical probe 1 is to be inserted. In a state in which the locking mechanisms (to be described later) provided to the output intensity measurement portion 500 are engaged to the grooves 221a and 221b of the tip end portion 220, an output intensity of laser light from the optical probe main body 100 is measured.

The lock release button 501 is one that is pressed to release the engagement between the locking mechanisms and the grooves 221a and 221b so that the tip end portion 220 of the applicator 200 is made to be detachable from the output intensity measurement portion 500.

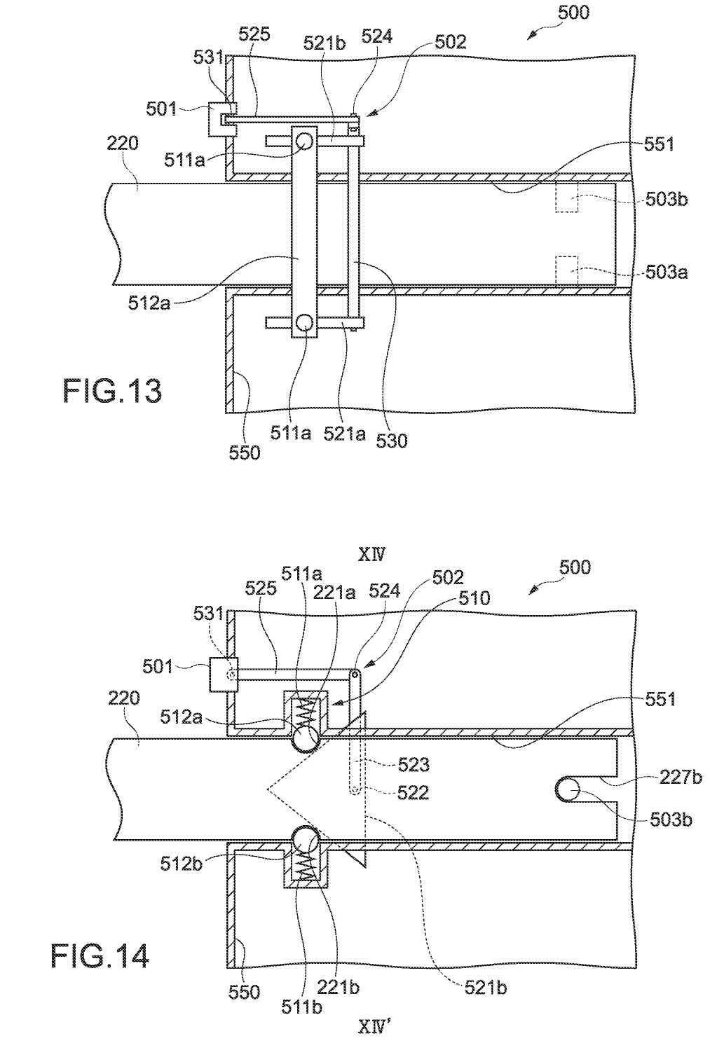

As shown in FIGS. 13 to 18, the output intensity measurement portion 500 includes a receptacle 550, the shutter member open pins 503a and 503b as the engagement mechanisms, locking mechanisms 510, a lock release mechanism 502, a micro switch 560 as an insertion detector, and a light detector 505.

As shown in FIGS. 13 and 14, the receptacle 550 includes an insertion hole 551 into which the tip end portion 220 of the applicator 200 of the optical probe 1 is to be inserted.

As shown in FIG. 14, the locking mechanisms 510 include springs 511a and 511b and locking rods 512a and 512b. The two springs 511a are provided to sandwich the tip end portion 220 and be opposed to each other on both sides thereof as viewed from the above as shown in FIG. 13. Similarly, the two springs 511b are also provided to sandwich the tip end portion 220 and be opposed to each other on both sides thereof as viewed from the above. The two springs 511a (511b) are fixedly provided to the receptacle 550. Moreover, to each of both end portions of the locking rod 512a (512b), one spring 511a (511b) is connected. By the engagement of the locking rod 512a (512b) with the groove 221a (221b) of the tip end portion 220, a position of the tip end portion 220 in the output intensity measurement portion 500 is fixed and locked.

As shown in FIGS. 13 and 14, the lock release mechanism 502 includes a triangle first release plate 521a and a triangle second release plate 521b, a first coupling rod 530, a second coupling rod 523, a third coupling rod 525, a first coupling member 522, a second coupling member 524, a third coupling member 531, and the lock release button 501.

The triangle second release plate 521b and the triangle first release plate 521a each have, as shown in FIG. 14, an isosceles triangle shape in a plane. The second release plate 521b and the first release plate 521a are provided such that the apex of a corner formed by two sides of each isosceles triangle, which have the same length, is oriented to a direction opposite to an insertion direction of the tip end portion 220, that is, a detachment direction of the tip end portion 220. The second release plate 521b and the first release plate 521a are provided in an inside (right-hand side in FIGS. 13 and 14) of the output intensity measurement portion 500 relative to the locking mechanisms 510. The first release plate 521a and the second release plate 521b are in contact with the locking rods 512a and 512b.

The first release plate 521a and the second release plate 521b are fixedly connected to the first coupling rod 530 provided to a direction orthogonal to the longitudinal direction of the tip end portion 220. Moreover, the second release plate 521b is coupled to the second coupling rod 523 by the first coupling member 522. With the first coupling member 522 being a support point, a positional relationship between the second release plate 521b and the second coupling rod 523 changes. The second coupling rod 523 is coupled to the third coupling rod 525 via the second coupling member 524. The second coupling member 524 changes a positional relationship between the second coupling rod 523 and the third coupling rod 525. The third coupling rod 525 is coupled to the lock release button 501 by the third coupling member 531.

As shown in FIGS. 13 and 14, when the tip end portion 220 is inserted into the output intensity measurement portion 500, the locking rod 512a is engaged and locked to the groove 221a and the locking rod 512b is engaged and locked to the groove 221b. Moreover, the shutter member open pin 503a is engaged to the cutout 227a and the shutter member open pin 503b is engaged to the cutout 227b. At this time, the springs 511a and 511b are in an expanded state. The first release plate 521a and the second release plate 521b are in contact with the locking rods 512a and 512b.

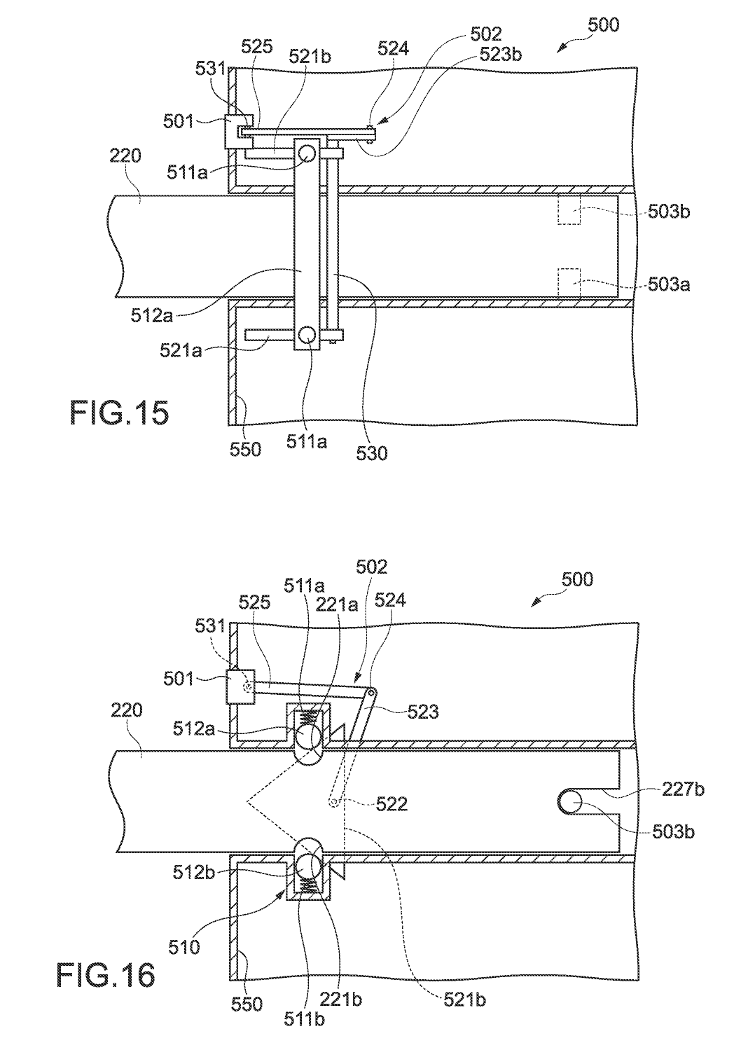

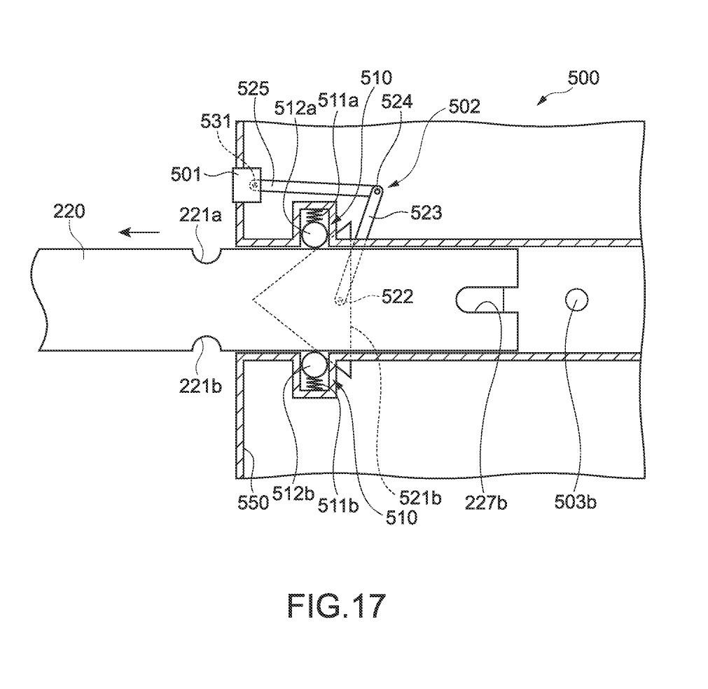

As shown in FIGS. 15 and 16, by pressing the lock release button 501, the third coupling rod 525 is pushed to the inside of the output intensity measurement portion 500 and the second release plate 521b coupled to the third coupling rod 525 via the second coupling rod 523 moves in the detachment direction. Also, the first release plate 521a cooperates with the second release plate 521b via the first coupling rod 530 and moves in the detachment direction. Due to the movements of the first release plate 521a and the second release plate 521b in the detachment direction, the locking rods 512a and 512b being in contact with them are pushed to move in the upper and lower directions in FIG. 16, respectively. Also, the springs 511a and 511b are contracted. Accordingly, the locking rod 512a is disengaged from the groove 221a and the locking rod 512b is disengaged from the groove 221b, so that the lock is released. After that, as shown in FIG. 17, in the lock released state, the tip end portion 220 is detached from the output intensity measurement portion 500.

As shown in FIG. 13, the shutter member open pins 503a and 503b are provided to be opposed to each other in the insertion hole 551 of the receptacle 550. During the insertion of the tip end portion 220, the shutter member open pins 503a and 503b are engaged to the cutouts 227a and 227b provided to the tip end portion 220.

The light detector 505 is one that detects an output intensity of laser light emitted from the light-emitting portion 102 of the optical probe 1. As the light detector 505, a light attenuator, an integrating sphere, a photodiode, a thermopile, or the like can be used.

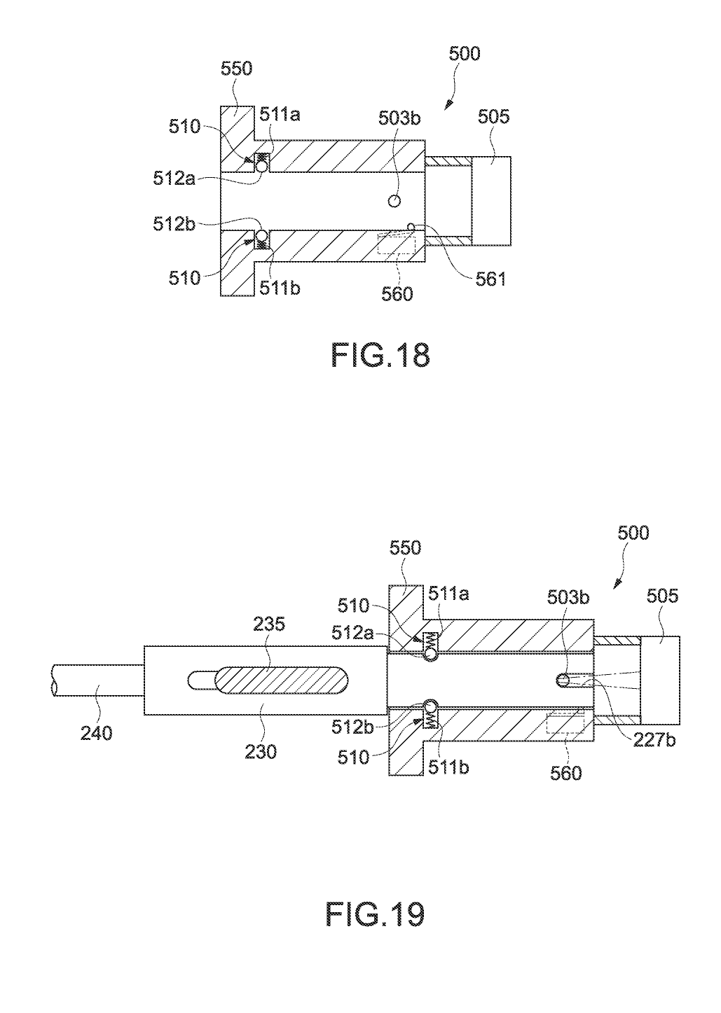

As shown in FIGS. 18 and 19, the micro switch 560 is provided between a line linking the shutter member open pins 503a and 503b to each other and a line linking the locking mechanisms 510 to each other. The micro switch 560 is one that detects the insertion of the tip end portion 220 of the optical probe 1. When the micro switch 560 detects the insertion of the tip end portion 220, it is determined that measurement of laser light output intensity has been prepared. With this configuration, since laser light is not output with the tip end portion 220 being incompletely inserted, it is possible to prevent laser light from leaking to the outside due to the incomplete insertion. The micro switch 560 includes an actuator 561. When a force applied to the actuator 561 due to the insertion of the tip end portion 220 is transmitted to a spring mechanism inside the micro switch 560 via the actuator 561, a movable contact point of the micro switch 560 is moved to turn on the switch so that measurement of laser light output intensity is enabled.

[Measurement Method for Laser Light Output Intensity of Optical Probe by the Laser Apparatus]

Next, a measurement method for laser light output intensity of the optical probe 1 using the laser apparatus 300 including the above-mentioned optical power meter.

First, the user opens the packed optical probe 3 shown in FIG. 11 and removes the optical probe 1 therefrom. In a state before the tip end portion 220 of the optical probe 1 is inserted into the output intensity measurement portion 500, the shutter member 222 is closed as shown in FIGS. 3 and 4 and the optical probe main body 100 is, as shown in FIGS. 7 and 8, sandwiched between the optical probe main body upper fixing member 233 and the optical probe main body lower fixing member 232.

Subsequently, as shown in FIG. 12, the light input portion 101 of the optical probe 1 is connected to the laser light source 301 of the laser apparatus 300 including the optical power meter. After that, the tip end portion 220 is inserted into the output intensity measurement portion 500.

When the tip end portion 220 is inserted into the insertion hole 551 of the output intensity measurement portion 500, the tip end portion 220 pushes the locking rod 512a in the upper direction and the locking rod 512b in the lower direction, and the shutter member open pins 503a and 503b move in the cutouts 227a and 227b, respectively. As shown in FIGS. 13 and 14, when the locking rod 512a is engaged to the groove 221a and the locking rod 512b is engaged to the groove 221b, the tip end portion 220 is fixed and locked in the insertion hole 551.

Almost simultaneous with the lock, as shown in FIGS. 5 and 6, the shutter member open pins 503a and 503b as the engagement mechanisms are engaged to the cutouts 227a and 227b as the engagement portions. The shutter member open pins 503a and 503b push the shutter member shafts 225 in the detachment direction being a direction opposite to the insertion direction of the applicator 200. When the shutter member shafts 225 are pushed by the shutter member open pins 503a and 503b, the shutter member shafts 225 and the shutter member 222 fixedly connected thereto rotate with respect to the pins 226. Then, the shutter member 222 is opened and the light-emitting portion 102 is exposed. As described above, engagement action when the cutouts 227a and 227b are engaged to the shutter member open pins 503a and 503b is used to open the shutter member 222.

Further, the insertion into the output intensity measurement portion 500 is detected by the micro switch 560.

After the tip end portion 220 of the optical probe 1 is completely inserted into the output intensity measurement portion 500, laser light is input from the laser light source 301 into the light input portion 101 of the optical probe 1, and as shown in FIG. 19, laser light is emitted from the light-emitting portion 102. The light emitted from the light-emitting portion 102 is detected by the light detector 505. Then, an output intensity determined based on the detection result is displayed on the display screen 302 of the laser apparatus 300 including the optical power meter that is shown in FIG. 12.

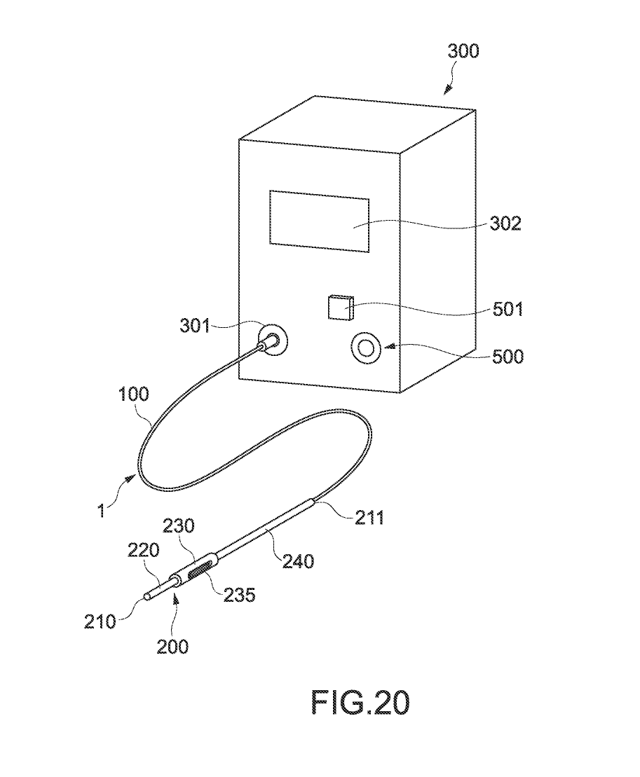

After measurement of an output intensity of laser light, as shown in FIGS. 15 and 16, by pressing the lock release button 501, the third coupling rod 525 is pushed to the inside of the output intensity measurement portion 500. Then, the second release plate 521b coupled to the third coupling rod 525 via the second coupling rod 523 moves in the detachment direction. Also, the first release plate 521a also cooperates with the second release plate 521b via the first coupling rod 530 and move in the detachment direction. Due to the movement of the first release plate 521a and the second release plate 521b in the detachment direction, the locking rods 512a and 512b being in contact with them are pushed to move in the upper and lower directions in FIG. 16, respectively. At this time, the springs 511a and 511b are in a contracted state. Accordingly, the locking rod 512a is disengaged from the groove 221a and the locking rod 512b is disengaged from the groove 221b, so that the lock is released. After that, as shown in FIG. 17, in the lock released state, the tip end portion 220 is detached from the output intensity measurement portion 500. As shown in FIG. 20, the tip end portion 220 of the applicator 200 is completely pulled out of the output intensity measurement portion 500.

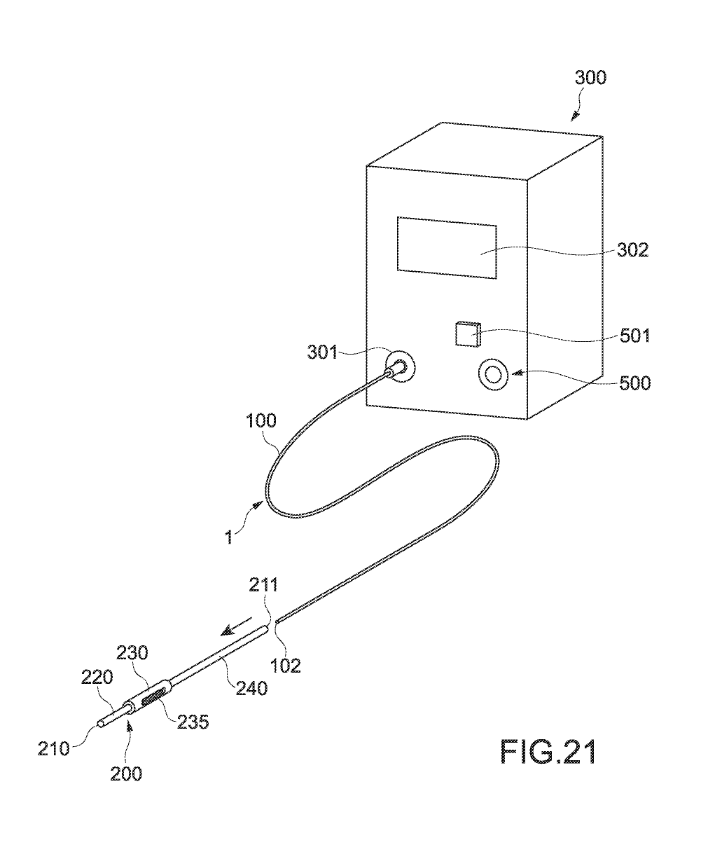

Subsequently, by the user sliding the applicator attachment and detachment slide button 235 of the sandwiching portion 230, the sandwiching by the sandwiching mechanism of the sandwiching portion 230 is released. That is, as shown in FIGS. 9 and 10, by sliding the applicator attachment and detachment slide button 235, the protruding portions 2351 move over the tilted surfaces 2321 from the right hand to the left hand with respect to the optical probe main body lower fixing member 232. With this operation, the protruding portions 2351 move from a lower portion side to a peak portion side of the tilted surfaces 2321 while being in contact with the tilted surfaces 2321. The optical probe main body lower fixing member 232 is pushed to move in the lower direction in the figure by an amount of change of a contact position between the protruding portions 2351 and the tilted surfaces 2321 in a height direction. Then, the springs 236 are contracted due to the movement of the optical probe main body lower fixing member 232 in the lower direction in the figure. Due to this contraction of the springs 236, the optical probe main body upper fixing member 233 and the optical probe main body lower fixing member 232 move away from each other and the sandwiching of the optical probe main body 100 by the sandwiching mechanism is released. In the sandwiching released state, the optical probe main body 100 is gradually pulled out of the other end portion 211 of the applicator 200, and the applicator 200 is detached from the optical probe 1 as shown in FIG. 21.

As described above, since the optical probe is equipped with the applicator, the area of the optical probe main body, which is covered with the applicator, is prevented from being brought close to or into contact with an unsanitary area. Thus, it is possible to reliably secure cleanness of the optical probe main body. Further, in the state in which the optical probe is equipped with the applicator, an output intensity of laser light can be checked. Thus, it is not necessary to subject the applicator to sterilization for each use, which contributes to high work efficiency.

Moreover, the shutter member is provided and this shutter member is opened by engagement action when the cutouts and the shutter member open pins are engaged to each other. Therefore, until the optical probe is completely inserted into the output intensity measurement portion, the light-emitting portion is blocked by the shutter member and prevented from being brought close to or into contact with an unsanitary area. Thus, it is possible to reliably secure cleanness of the light-emitting portion of the optical probe main body.

Hereinafter, modified examples will be described. Here, the same configurations as those of the above-mentioned embodiment will be denoted by the same reference symbols and descriptions thereof will be omitted.

### Modified Example 1

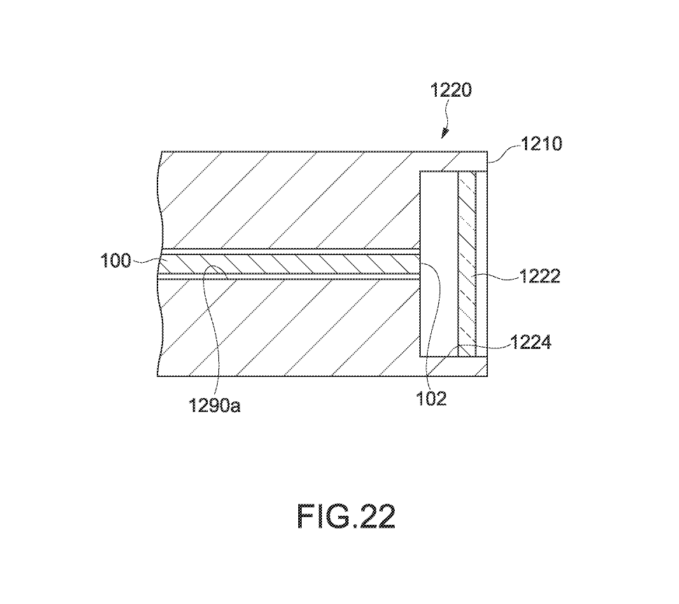

In the above-mentioned embodiment, the openable and closable shutter member that blocks the light-emitting portion is provided. A modified example 1 is different from the above-mentioned embodiment mainly in that as shown in FIG. 22, a window portion 1222 that blocks a light-emitting portion 102 and is capable of transmitting laser light therethrough is provided in place of the shutter member.

FIG. 22 is a partial cross-sectional view of a vicinity of one end portion 1210 of a tip end portion 1220 of an optical probe. The tip end portion 1220 includes an insertion hole 1290a into which an optical probe main body 100 is to be inserted, a recess portion 1224 provided on a side of the one end portion 1210, and the window portion 1222 provided in the recess portion 1224. The window portion 1222 is provided to close an opening of the recess portion 1224 and is formed of material through which laser light can be transmitted. With this structure, during measurement of a light output intensity of laser light output from the light-emitting portion 102, the output intensity can be measured with the window portion being attached without removing the window portion. Thus, also during measurement, it is possible to secure cleanness of the light-emitting portion 102.

### Modified Example 2

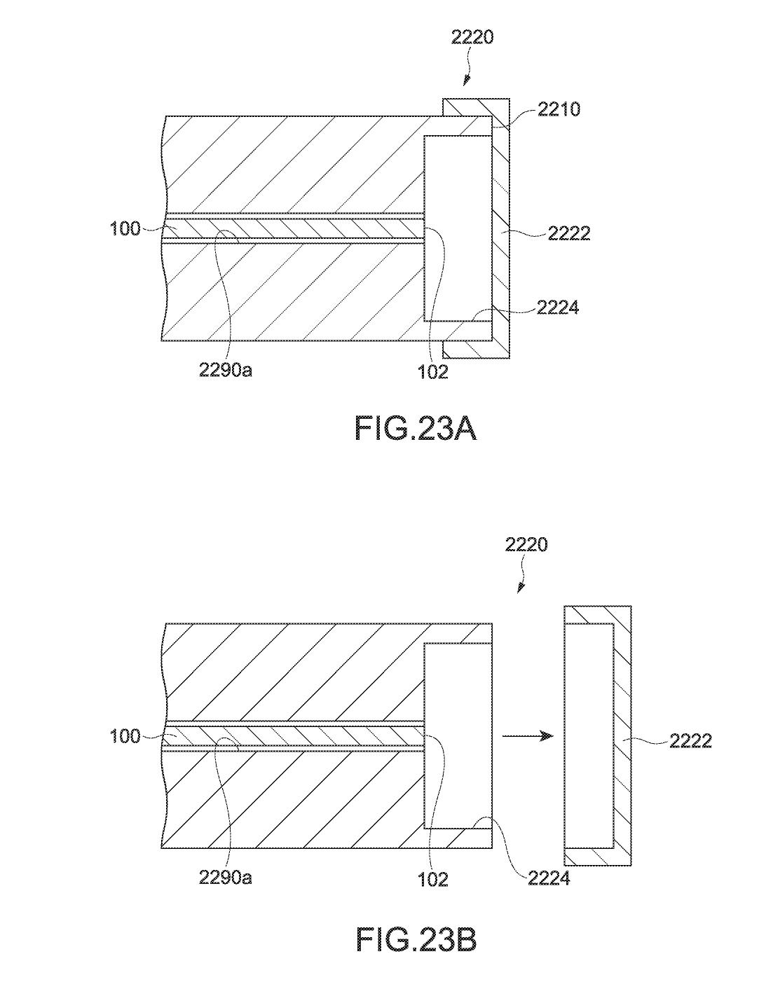

In the above-mentioned embodiment, the openable and closable shutter member that blocks the light-emitting portion is provided. However, in a modified example 2, as shown in FIG. 23, a lid 2222 that blocks an light-emitting portion 102 may be provided in place of the shutter member.

As shown in FIG. 23, a tip end portion 2220 of an optical probe includes an insertion hole 2290a into which an optical probe main body 100 is to be inserted, a recess portion 2224 provided on a side of one end portion 2210, and the lid 2222 provided to close the recess portion 2224. As shown in FIG. 23A, outside of an operation time and an output intensity measurement time, the lid 2222 blocks the light-emitting portion 102. As shown in FIG. 23B, during the operation time and the output intensity measurement time, the lid 2222 is removed. The lid 2222 is formed to have a size larger than that of an insertion hole of an output intensity measurement portion of a laser apparatus, which can prevent the tip end portion 2220 from being inserted into the output intensity measurement portion with the lid 2222 being attached.

### Modified Example 3

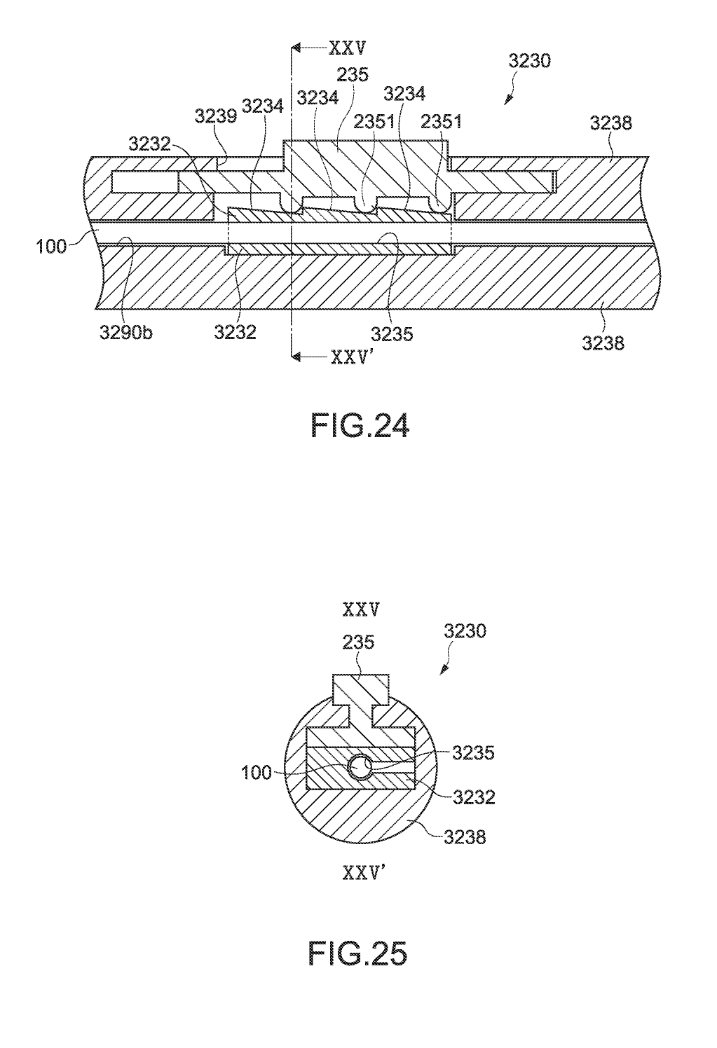

In the above-mentioned embodiment, the springs are used in the sandwiching mechanism of the sandwiching portion of the applicator to apply an elastic force. However, as shown in FIGS. 24 to 27, as a holding member that holds the optical probe main body, an the elastic member 3232 may be used to apply an elastic force.

As shown in FIGS. 24 to 27, a sandwiching portion 3230 of an optical probe includes an insertion hole 3290b into which an optical probe main body 100 is to be inserted, a recess portion 3239 provided for an area in which an applicator attachment and detachment slide button 235 moves, the elastic member 3232, and a first member 3238.

The elastic member 3232 is one that sandwiches and fixes the optical probe main body 100, and includes an insertion portion 3235 into which the optical probe main body 100 is to be inserted. Regarding the elastic member 3232, on its upper surface, a plurality of tilted surfaces 3234 are provided. The tilted surfaces 3232 are arranged in parallel at constant intervals in a longitudinal direction of an applicator 200. In this case, by sliding the applicator attachment and detachment slide button 235 in a right-hand direction in the figures, the sandwiching of the optical probe main body by the sandwiching mechanism is released. Further, by sliding the applicator attachment and detachment slide button 235 to a left-hand direction, the sandwiching of the optical probe main body by the sandwiching mechanism is performed. The tilted surfaces 3234 each have a height gradually increasing from the right hand to the left hand. In other words, the tilted surfaces 3234 are provided to each have a height increasing toward a direction opposite to a movement direction of the applicator attachment and detachment slide button 235 upon the release of the sandwiching. Peak portions of the tilted surfaces 3234 extend in parallel to a longitudinal direction of protruding portions 2351. Each of the tilted surfaces 3234 is provided to correspond to each of the protruding portions 2351.

As shown in FIGS. 24 and 25, when the applicator attachment and detachment slide button 235 is positioned on a right-hand side in a slide recess portion 3239 in FIG. 24, the protruding portions 2351 of the applicator attachment and detachment slide button 235 are positioned on lower portions of the tilted surfaces 3234. At this time, no force is applied to the elastic member 3232 and the sandwiching of the optical probe main body 100 by the elastic member 3232 is released. In such a state, the applicator is detachable from the optical probe main body 100.

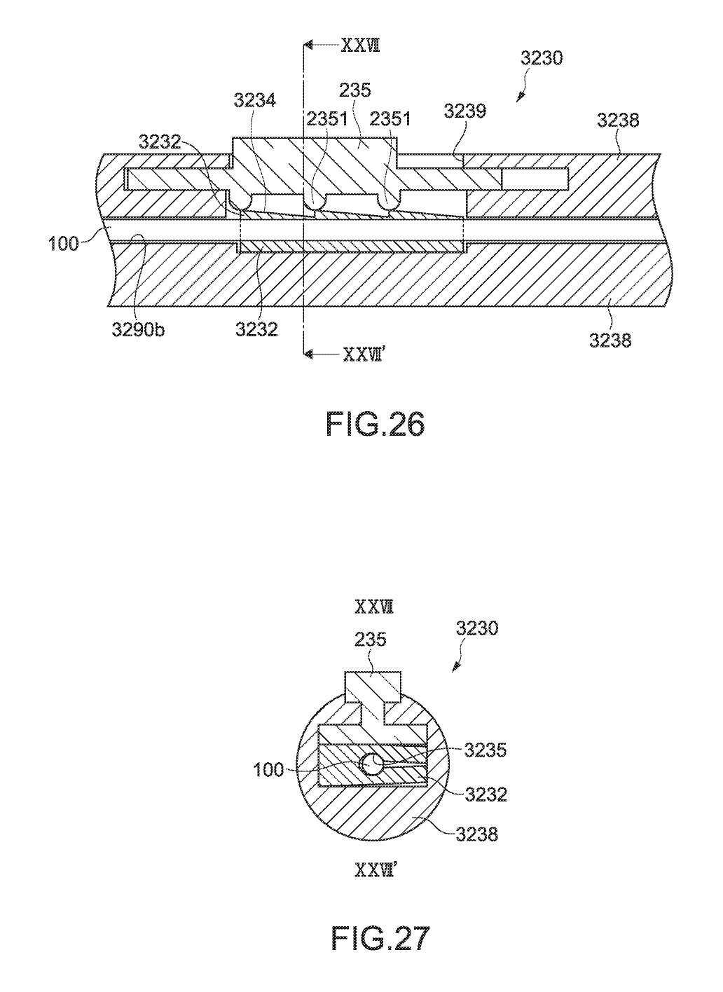

As shown in FIGS. 26 and 27, when the applicator attachment and detachment slide button 235 is positioned on a left-hand side in the slide recess portion 3239 in FIG. 26, the protruding portions 2351 of the applicator attachment and detachment slide button 235 are positioned on the peak portions of the tilted surfaces 3234. At this time, a force is applied to the elastic member 3232 from the above and the elastic member 3232 is deformed and crushed so that the elastic member 3232 sandwiches the optical probe main body 100.

As described above, the elastic member 3232 is used to sandwich the optical probe main body 100 with an elastic force, and by releasing this elastic force, the optical probe main body 100 is made to be detachable from the applicator.

### Modified Example 4

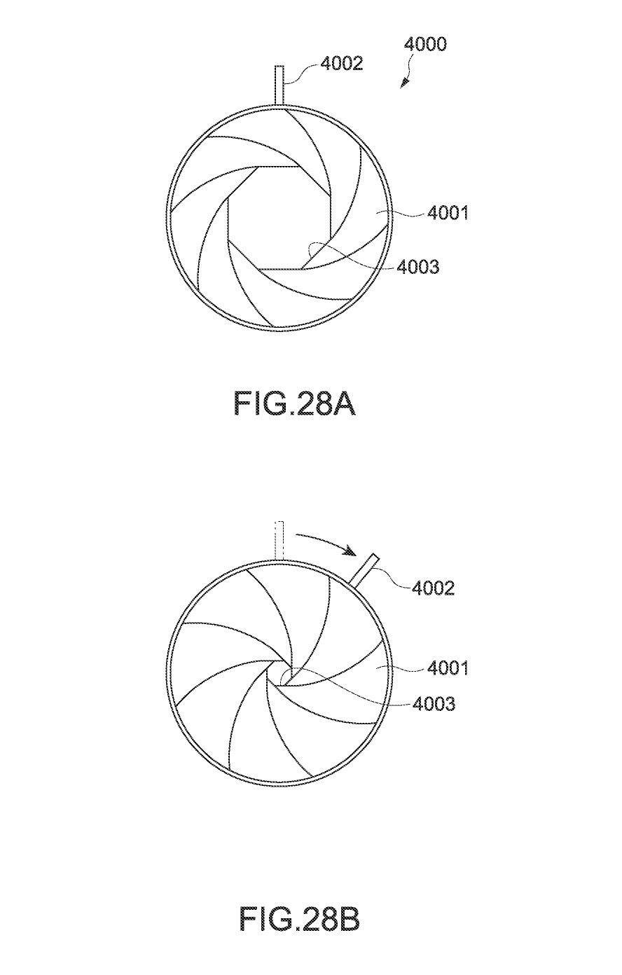

In the above-mentioned embodiment, the elastic member including the springs and the like is used in the sandwiching mechanism of the sandwiching portion of the applicator to sandwich the optical probe main body with an elastic force. A squeezing portion 4000 shown in FIG. 28 may sandwich the optical probe main body.

FIG. 28A shows a state of the squeezing portion 4000 when the sandwiching of the optical probe main body is released. FIG. 28B shows a state of the squeezing portion 4000 when the optical probe main body is sandwiched. The squeezing portion 4000 includes a plurality of blades 4001 and a lever 4002, the lever 4002 being provided on a frame on an outer circumferential side. By rotating the blades 4001 together in synchronization with rotation of the lever 4002, a size of a squeeze hole 4003 can be changed. When as shown in FIG. 28A, the sandwiching of the optical probe main body is released, the squeeze hole 4003 has a large size. When as shown in FIG. 28B, when the optical probe main body is sandwiched, the squeeze hole 4003 has a small size.

### Modified Example 5

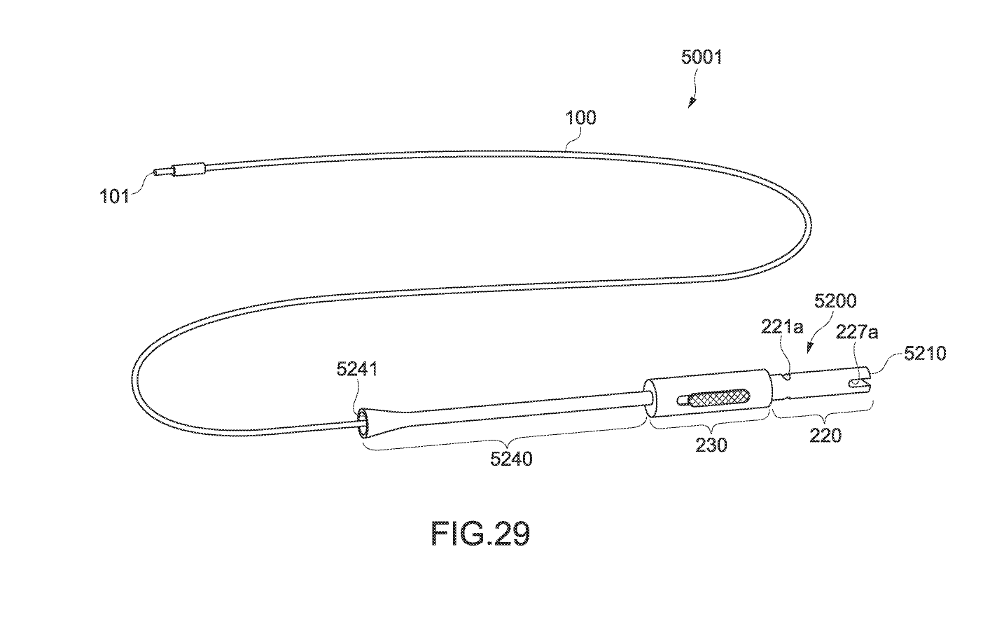

In the above-mentioned embodiment, a diameter of the cross-section of the insertion hole of the extending portion of the applicator is not varied but constant in a longitudinal direction thereof. However, as shown in FIG. 29, an end portion thereof may have a trumpet shape.

As shown in FIG. 29, an optical probe 5001 according to a modified example 5 includes an optical probe main body 100 and an applicator 5200. The applicator 5200 includes a tip end portion 220, a sandwiching portion 230, and an extending portion 3240. The applicator 3200 includes one end portion 5210 on a side of a light-emitting portion of the optical probe main body and the other end portion 5241 on the opposite side. The applicator 5200 has an insertion hole into which the optical probe main body 100 is to be inserted. The insertion hole has a size increasing at the other end portion 5241 of the applicator 5200. With this structure, when the applicator 5200 is detached from the optical probe main body 100 by pulling out the optical probe main body 100 from the other end portion 5241 of the applicator 5200, the light-emitting portion of the optical probe main body 100 is less likely to be brought into contact with the other end portion 5241. Therefore, even if dirt and the like are adhered to the other end portion 5241 of the applicator 5200, the light-emitting portion is less likely to be brought into contact with the other end portion 5241 so that the dirt is adhered to the light-emitting portion. Thus, it is easier to secure cleanness of the optical probe main body.

The present disclosure also takes the following configuration.

(1) An optical probe, including:

an optical probe main body including a light-emitting portion configured to emit laser light; and

a covering member configured to cover a part of the optical probe main body from the light-emitting portion such that laser light from the light-emitting portion can be emitted to an outside, and to be detachable from the optical probe main body.

(2) The optical probe according to (1) above,

in which the covering member includes
an openable and closable shutter member configured to block the light-emitting portion,
an engagement portion configured to be, when the optical probe is inserted into a measurement portion configured to measure an output intensity of laser light from the light-emitting portion, engaged to an engagement mechanism provided to the measurement portion, and
a link mechanism configured to open, when the engagement portion is engaged to the engagement mechanism, the shutter member by engagement action.

(3) The optical probe according to (1) or (2) above,

in which the covering member includes a sandwiching mechanism configured to sandwich the optical probe main body with an elastic force and to make the covering member detachable from the optical probe main body by releasing the elastic force.

(4) The optical probe according to any of (1) to (3) above
in which the covering member includes a groove configured to be, when the optical probe is inserted into the measurement portion, engaged to a locking mechanism provided to the measurement portion.

(5) The optical probe according to (1) above, in which

the covering member includes
a tip end portion configured to cover an end portion on a side of the light-emitting portion of the optical probe main body and to be engaged to a measurement portion configured to measure an output intensity of laser light from the light-emitting portion,
a sandwiching portion that is connected to the tip end portion and configured to sandwich the optical probe main body by a sandwiching mechanism configured to be detachable from the optical probe main body, and
a tubular extending portion that is connected to the sandwiching portion and configured to hold the optical probe main body.

(6) The optical probe according to any of (1) to (5) above, in which

the covering member includes an insertion hole into which the optical probe main body is to be inserted, and

the insertion hole has a size increasing at a second end portion on an opposite side to a first end portion of the covering member on a side of the light-emitting portion.

(7) The optical probe according to any of (1) to (6) above,

in which the covering member is formed of material that can be subjected to ethylene oxide gas sterilization or radiation sterilization.

(8) The optical probe according to any of (1) to (7),

in which the covering member includes a removable lid configured to block the light-emitting portion.

(9) The optical probe according to (1) or (5) above,

in which the covering member includes a window portion configured to block the light-emitting portion and to be capable of transmitting laser light therethrough.

(10) A covering member, configured to cover a part of an optical probe main body including a light-emitting portion configured to emit laser light, from the light-emitting portion, such that laser light from the light-emitting portion of the optical probe main body can be emitted to an outside, and to be detachable from the optical probe main body.

(11) The covering member according to (10) above, further including:

an openable and closable shutter member configured to block the light-emitting portion;

an engagement portion configured to be, when the optical probe is inserted into a measurement portion configured to measure an output intensity of laser light from the light-emitting portion, engaged to an engagement mechanism provided to the measurement portion; and

a link mechanism configured to open, when the engagement portion is engaged to the engagement mechanism, the shutter member by engagement action.

(12) The covering member according to (10) or (11) above, further including a sandwiching mechanism configured to sandwich the optical probe main body with an elastic force and to make the covering member detachable from the optical probe main body by releasing the elastic force.

(13) The covering member according to any of (10) to (12), further including a groove configured to be, when the optical probe is inserted into the measurement portion, engaged to a locking mechanism provided to the measurement portion.

(14) The covering member according to (10) above, further including:

a tip end portion configured to cover an end portion on a side of the light-emitting portion of the optical probe main body and to be engaged to a measurement portion configured to measure an output intensity of laser light from the light-emitting portion;

a sandwiching portion that is connected to the tip end portion and configured to sandwich the optical probe main body by a sandwiching mechanism configured to be detachable from the optical probe main body; and

a tubular extending portion that is connected to the sandwiching portion and configured to hold the optical probe main body.

(15) The covering member according to any of (10) to (14), further including an insertion hole into which the optical probe main body is to be inserted,

in which the insertion hole has a size increasing at a second end portion on an opposite side to a first end portion of the covering member on a side of the light-emitting portion.

(16) The covering member according to any of (10) to (15), formed of material that can be subjected to ethylene oxide gas sterilization or radiation sterilization.

(17) The covering member according to (10) or (14), further including a removable lid configured to block the light-emitting portion.

(18) The covering member according to (10) or (14), further including a window portion configured to block the light-emitting portion and to be capable of transmitting laser light therethrough.

(19) A measurement method for an optical probe, the optical probe including
an optical probe main body including a light-emitting portion configured to emit laser light, and
a covering member including an engagement portion and an openable and closable shutter member configured to cover a part of the optical probe main body from the light-emitting portion and to block the light-emitting portion, the covering member being configured to be detachable from the optical probe main body, the measurement method including:

inserting the part on a side of the light-emitting portion of the optical probe into a measurement portion of an optical power meter, the part being covered with the covering member, the measurement portion being configured to measure an output intensity of laser light;

engaging the engagement portion to an engagement mechanism provided to the measurement portion of the optical power meter by the insertion to open the shutter member by engagement action when the engagement portion is engaged to the engagement mechanism; and

outputting laser light from the light-emitting portion with the engagement portion being engaged to the engagement mechanism to measure laser light from the light-emitting portion by the optical power meter.

(20) The measurement method for an optical probe, according to (19) above,

in which by the insertion, a locking mechanism provided to the measurement portion is engaged to a groove provided to the covering member.

(21) An optical power meter, including:

a measurement portion configured to measure an output intensity of laser light from a light-emitting portion of an optical probe, the optical probe including
an optical probe main body including the light-emitting portion configured to emit laser light, and
a covering member including
   an engagement portion, and
   an openable and closable shutter member configured to cover a part of the optical probe main body from the light-emitting portion and to block the light-emitting portion, the covering member being configured to be detachable from the optical probe main body; and

an engagement mechanism that is provided to the measurement portion and configured to be, when the optical probe is inserted into the measurement portion, engaged to the engagement portion to open the shutter member by engagement action.

(22) The optical power meter according to (21) above, further including a locking mechanism configured to be engaged to a groove provided to the covering member when the optical probe is inserted into the measurement portion.

The present disclosure contains subject matter related to that disclosed in Japanese Priority Patent Application JP 2011-122275 filed in the Japan Patent Office on May 31, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical probe, comprising:
an optical probe main body including a light-emitting portion configured to emit laser light; and
a covering member configured to cover a part of the optical probe main body from the light-emitting portion such that laser light from the light-emitting portion can be emitted to an outside, and to be detachable from the optical probe main body.

2. The optical probe according to claim 1,
wherein the covering member includes
an openable and closable shutter member configured to block the light-emitting portion,
an engagement portion configured to be, when the optical probe is inserted into a measurement portion configured to measure an output intensity of laser light from the light-emitting portion, engaged to an engagement mechanism provided to the measurement portion, and
a link mechanism configured to open, when the engagement portion is engaged to the engagement mechanism, the shutter member by engagement action.

3. The optical probe according to claim 1,
wherein the covering member includes a sandwiching mechanism configured to sandwich the optical probe main body with an elastic force and to make the covering member detachable from the optical probe main body by releasing the elastic force.

4. The optical probe according to claim 2,
wherein the covering member includes a groove configured to be, when the optical probe is inserted into the measurement portion, engaged to a locking mechanism provided to the measurement portion.

5. The optical probe according to claim 1, wherein
the covering member includes
a tip end portion configured to cover an end portion on a side of the light-emitting portion of the optical probe main body and to be engaged to a measurement portion configured to measure an output intensity of laser light from the light-emitting portion,
a sandwiching portion that is connected to the tip end portion and configured to sandwich the optical probe main body by a sandwiching mechanism configured to be detachable from the optical probe main body, and
a tubular extending portion that is connected to the sandwiching portion and configured to hold the optical probe main body.

6. The optical probe according to claim 1,
wherein the covering member includes an insertion hole into which the optical probe main body is to be inserted, and
the insertion hole has a size increasing at a second end portion on an opposite side to a first end portion of the covering member on a side of the light-emitting portion.

7. The optical probe according to claim 1,
wherein the covering member is formed of material that can be subjected to ethylene oxide gas sterilization or radiation sterilization.

8. The optical probe according to claim 1,
wherein the covering member includes a removable lid configured to block the light-emitting portion.

9. The optical probe according to claim 1,
wherein the covering member includes a window portion configured to block the light-emitting portion and to be capable of transmitting laser light therethrough.

10. A covering member, configured to cover a part of an optical probe main body including a light-emitting portion configured to emit laser light, from the light-emitting portion, such that laser light from the light-emitting portion of the optical probe main body can be emitted to an outside, and to be detachable from the optical probe main body.

11. A measurement method for an optical probe, the optical probe including
an optical probe main body including a light-emitting portion configured to emit laser light, and
a covering member including an engagement portion and an openable and closable shutter member configured to cover a part of the optical probe main body from the light-emitting portion and to block the light-emitting portion, the covering member being configured to be detachable from the optical probe main body, the measurement method comprising:
inserting the part on a side of the light-emitting portion of the optical probe into a measurement portion of an optical power meter, the part being covered with the covering member, the measurement portion being configured to measure an output intensity of laser light;
engaging the engagement portion to an engagement mechanism provided to the measurement portion of the optical power meter by the insertion to open the shutter member by engagement action when the engagement portion is engaged to the engagement mechanism; and
outputting laser light from the light-emitting portion with the engagement portion being engaged to the engagement mechanism to measure laser light from the light-emitting portion by the optical power meter.

12. An optical power meter, comprising:
a measurement portion configured to measure an output intensity of laser light from a light-emitting portion of an optical probe, the optical probe including
an optical probe main body including the light-emitting portion configured to emit laser light, and
a covering member including
an engagement portion, and
an openable and closable shutter member configured to cover a part of the optical probe main body from the light-emitting portion and to block the light-emitting portion, the covering member being configured to be detachable from the optical probe main body; and
an engagement mechanism that is provided to the measurement portion and configured to be, when the optical probe is inserted into the measurement portion, engaged to the engagement portion to open the shutter member by engagement action.
